(19) United States
(12) Patent Application Publication
(10) Pub. No.: US 2026/0319833 A1
(43) Pub. Date: Oct. 15, 2026

(54) SCHEDULING EXECUTION OF PROCESSING JOBS

(71) Applicant: Arm Limited, Cambridge (GB)

(72) Inventors: Jakob Axel FRIES, Lund (SE); Olof Henrik UHRENHOLT, Lomma (SE)

(21) Appl. No.: 19/178,277

(22) Filed: Apr. 14, 2025

(51) Int. Cl. G06F 9/48

(52) U.S. Cl. CPC G06F 9/4881

(57) ABSTRACT

A computer-implemented method 300 for scheduling execution of at least one processing job on single instruction, multiple thread (SIMT) processing circuitry. The method comprises: 302 receiving at least one processing job comprising one or more workgroups, wherein each workgroup comprises one or more threads, and wherein each thread is associated with respective coordinates within an operation space of the at least one processing job; 304 analysing code to be executed by the SIMT processing circuitry during execution of the one or more threads to infer a storage access pattern of the one or more workgroups; 306 determining an iteration order for the one or more workgroups based on the storage access pattern; and 308 generating control information for scheduling execution of the one or more workgroups on the SIMT processing circuitry based on the iteration order.

### FIELD

The present technology relates to single instruction, multiple thread (SIMT) processing. In particular, the present technology relates to computer-implemented methods and systems for scheduling execution of at least one processing job on SIMT processing circuitry.

### BACKGROUND

Single instruction, multiple thread (SIMT) processing involves use of a plurality of execution units to execute a common program as a respective plurality of threads. Typically, each of the execution units execute code in lockstep with respect to the other execution units. This permits a saving in the amount of instruction decode circuitry required and increases the likelihood of achieving efficiency gains in memory accesses due to the memory accesses being correlated in a manner which permits them to be performed more efficiently. In a typical SIMT environment such as a graphics processing environment, threads in shader cores process graphical data for rendering. In a typical machine learning environment such as a neural network, execution units act on data in the form of tensors to perform learning and inferencing.

### SUMMARY

Aspects of the present technology provide a computer-implemented method, single instruction, multiple thread (SIMT) processing circuitry and a system comprising host processing circuitry and SIMT processing circuitry according to the appended claims.

According to an aspect of the present technology there is provided a computer-implemented method for scheduling execution of at least one processing job on single instruction, multiple thread processing circuitry, the method comprising: receiving at least one processing job comprising one or more workgroups, wherein each workgroup comprises one or more threads, and wherein each thread is associated with respective coordinates within an operation space of the at least one processing job; analysing code to be executed by the SIMT processing circuitry during execution of the one or more threads to infer a storage access pattern of the one or more workgroups; determining an iteration order for the one or more workgroups based on the storage access pattern; and generating control information for scheduling execution of the one or more workgroups on the SIMT processing circuitry based on the iteration order.

Optionally the SIMT processing circuitry is graphics processing circuitry and the at least one processing job comprises at least one of a graphics workload or a compute workload.

Optionally the method further comprises: providing the control information to the SIMT processing circuitry; executing, by the SIMT processing circuitry, the one or more workgroups based on the iteration order to produce output data; and storing, by the SIMT processing circuitry, the output data in storage.

Optionally the method further comprises: compressing the output data in one or more compression units.

Optionally the iteration order is determined such that the shape of the output data is aligned to the shape of the compression units.

Optionally the iteration order is determined on the basis of spatial locality of memory accesses during execution of the at least one processing job.

Optionally the at least one processing job has a job size specifying the number of workgroups in each direction.

Optionally each workgroup has a workgroup size specifying the number of threads to launch in each direction.

Optionally analysing the code to be executed by the SIMT processing circuitry during execution of the one or more threads comprises determining access footprints of the one or more workgroups.

Optionally the iteration order is based on the access footprints of the one or more workgroups.

Optionally the access footprint of each workgroup comprises at least a width dimension and a height dimension.

Optionally when the width dimension is greater than the height dimension, the iteration order is along a first direction, and otherwise the iteration order is along a second direction.

Optionally analysing the code to be executed by the SIMT processing circuitry during execution of the one or more threads comprises, for each workgroup: determining a size of the workgroup; and determining an access footprint of each thread; and combining the size of the workgroup and the access footprint of each thread to determine an access footprint of the workgroup while compensating for overlap.

Optionally the method comprises, for at least one workgroup, determining an access footprint of each thread as a default access footprint.

Optionally the iteration order is determined according to an iteration policy.

Optionally the at least one processing job operates on image data or tensor data.

Optionally the method is carried out by a driver executing on host processing circuitry.

According to an aspect of the present technology there is provided single instruction, multiple thread (SIMT) processing circuitry configured for executing at least one processing job comprising one or more workgroups, each workgroup comprising one or more threads, wherein each thread is associated with respective coordinates within an operation space of the at least one processing job, wherein the SIMT processing circuitry is configured to carry out a method comprising: receiving control information for scheduling execution of the one or more workgroups based on an iteration order, wherein the control information is indicative of the iteration order; and executing the one or more workgroups according to the iteration order to produce output data.

According to an aspect of the present technology there is provided a system comprising host processing circuitry and single instruction, multiple thread processing circuitry, wherein a driver executing on the host processing circuitry is configured to carry out a method comprising: receiving at least one processing job comprising one or more workgroups, wherein each workgroup comprises one or more threads, and wherein each thread is associated with respective coordinates within an operation space of the at least one processing job; analysing code to be executed by the SIMT processing circuitry during execution of the one or more threads to infer a storage access pattern of the one or more workgroups; determining an iteration order for the one or more workgroups based on the storage access pattern; and generating control information for scheduling execution of the one or more workgroups on the SIMT processing circuitry based on the iteration order.

Optionally the SIMT processing circuitry is graphics processing circuitry.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

Embodiments will now be described, with reference to the accompanying drawings, in which:

FIG. 1 shows an exemplary graphics processing pipeline;

FIG. 2 shows an exemplary processing system comprising SIMT processing circuitry;

FIG. 3 shows an exemplary computer-implemented method for scheduling execution of at least one processing job on SIMT processing circuitry;

FIG. 4 shows an exemplary operation space of a processing job, an exemplary access footprint workgroup and exemplary data in storage;

FIG. 5 shows an exemplary computer-implemented method for analysing code to be executed by SIMT processing circuitry during execution of one or more threads;

FIG. 6 shows an exemplary iteration order;

FIG. 7 shows a further exemplary iteration order;

FIG. 8 shows a further exemplary iteration order;

FIG. 9 shows a further exemplary iteration order; and

FIG. 10 shows computer-implemented method for executing at least one processing job comprising one or more workgroups on SIMT processing circuitry.

### DETAILED DESCRIPTION

The present technology relates to single instruction, multiple thread (SIMT) processing. In particular, the present technology relates to computer-implemented methods and systems for scheduling execution of at least one processing job on SIMT processing circuitry. In examples, the present technology may relate to graphics processing such as tile-based graphics processing, or may relate to processing of tensor data in a machine learning environment using a neural network. In particularly relevant examples, the present technology may relate to compute shaders in which a job (e.g. a graphics job or a compute job) is described at the API level in terms of workgroups.

Graphics processing is generally performed by first splitting a scene (e.g. a 3D model) to be displayed onto a number of similar basic components or “primitives”, which primitives are then subjected to the desired graphics processing operations. The graphics “primitives” are usually in the form of simple polygons, such as triangles. Once primitives and their vertices have been generated and defined, they can be further processed by a fragment processing pipeline, in order to generate the desired graphics processing output (render output), such as a frame for display. This usually involves determining which sampling points of an array of sampling points associated with the render output area to be processed are covered by a primitive, and then determining the appearance each sampling point should have (e.g. in terms of its colour) to represent the primitive at that sampling point. These processes are commonly referred to as rasterizing and rendering, respectively. The rendering process involves deriving the data, such as red, green and blue (RGB) colour values and an “alpha” (transparency) value, necessary to represent the primitive at the sampling points. Where necessary, newly generated data may be blended with data that has previously been generated for the sampling point in question.

In tile-based rendering, a render output is divided into a plurality of smaller regions, herein referred to as “tiles”. Each tile is rendered separately (typically one after another), and the rendered tiles are then recombined to provide the complete render output, e.g. a render pass or a frame to be displayed. A tile-based graphics processing pipeline includes one or more so-called tile buffers that store rendered fragment data at the end of the pipeline until a given tile is completed and written out to an external memory, such as a frame buffer, for use. In some tile-based graphics processing pipelines, the rendered fragment data is compressed before being written out to the external memory.

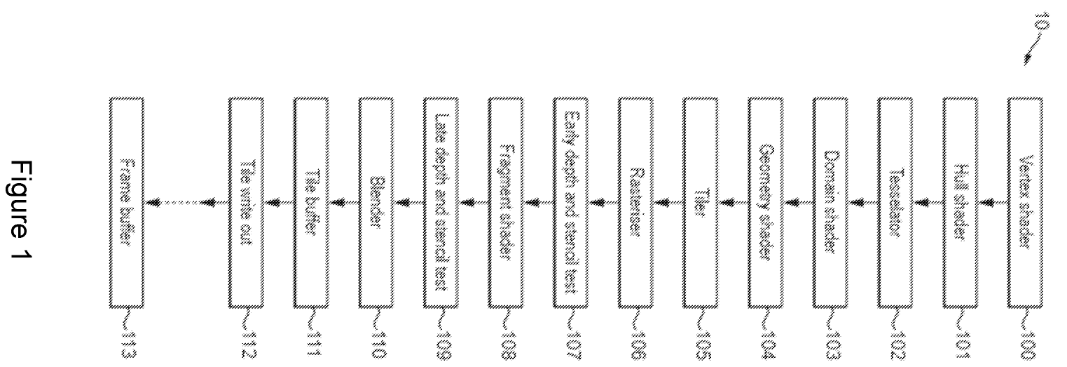

The exemplary graphics processing pipeline 10 shown in FIG. 1 is a tile-based renderer that produces tiles of a render output data array, such as an output frame to be displayed.

FIG. 1 shows the main elements and pipeline stages of the graphics processing pipeline 10. As will be appreciated by those skilled in the art, there may be other elements of the graphics processing pipeline that are not shown in FIG. 1. It should be noted here that FIG. 1 is only schematic, and that, for example, in practice, the shown functional units and pipeline stages may share significant hardware circuits, even though they are shown functionally as separate states in FIG. 1. It will also be appreciated that each of the stages, elements and units, etc., of the graphics processing pipeline 10 may be implemented as desired and may accordingly comprise, e.g., appropriate circuitry and/or processing logic, etc., for performing the necessary operation and functions.

The graphics processing pipeline 10 includes a number of stages, including vertex shader 100, a hull shader 101 (in DirectX, or a Tessellation Control Shader in Vulkan or OpenGL), a tesselator 102, a domain shader 103 (in DirectX, or a Tessellation Evaluation Shader in Vulkan or OpenGL), a geometry shader 104, a tiler 105, a rasterization stage 106, an early Z (depth) and stencil test stage 107, a renderer in the form of a fragment shading state 108, a late Z (depth) and stencil test stage 109, a blending stage 110, a tile buffer 111, and a tile write out stage 112 that performs downsampling and writeout (multisample resolve).

The vertex shader 100 takes the input data values (vertex attribute values) associated with the vertices, etc., defined for the output to be generated, and processes those data values to generate a set of corresponding “vertex shaded” output data values for use by subsequent stages of the graphics processing pipeline.

For a given output to be generated by the graphics processing pipeline, there may typically be a set of vertices defined for the output in question. The primitives to be processed for the output may then be indicated as comprising given vertices in the set of vertices for the graphics processing output being generated.

The vertex shading operation operates to transform the attributes for each vertex into a desired form for the subsequent graphics processing operations. This may comprise, in particular, transforming vertex position attribute values from the model or object space for which they are initially defined to the screen space in which the output of the graphics processing system is to be displayed, modifying the input data to take account of the effect of lighting in the image to be rendered, etc.

The vertex shading operation may also convert the originally defined vertex position coordinates to a different, e.g. lower precision, form to be used later on in the graphics processing pipeline.

The hull shader 101 performs operations on sets of patch control points and generates additional data known as patch constants. The tessellation stage 102 subdivides geometry to create higher order representations of the hull, and the domain shader 103 performs operations on vertices output by the tessellation stage (similar to a vertex shader). The geometry shader 104 may (if run) generate primitives such as triangles, points or lines for processing.

Once all the primitives to be rendered have been appropriately processed, e.g. transformed, and/or, e.g. generated by the geometry shader, the tiler 105 then determines which primitives need to be processed for each tile into which the render output has been divided for processing purposes. To do so, the tiler 105 compares the location of each primitive to be processed with the tile positions, and adds the primitive to a respective primitive list for each tile within which it determines the primitive could (potentially) fall. Any suitable and desired technique for sorting and binning primitives into tile lists, such as exact binning, bounding box binning or anything in between, may be used for the tiling process.

Once the tiler 105 has completed the preparation of the primitive tile lists (lists of primitives to be processed for each tile), each tile is then rendered. To do so, each tile is processed by the graphics processing pipeline stages shown in FIG. 1 that follow the tiler 105. Thus, when a given tile is being processed, each primitive that is to be processed for that tile (that is listed in a tile list for that tile) is passed to the rasteriser 106.

The rasterization stage 106 of the graphics processing pipeline 10 operates to rasterise the primitives into individual graphics fragments for processing. In particular, the rasteriser 106, particularly a primitive set-up stage (otherwise known as a triangle set-up unit, TSU) of the rasteriser 106, operates to determine, from the vertex shaded vertices provided to the primitive set-up stage, edge information representing each primitive edge of a primitive to be rasterised. This edge information is then passed to a rasterization stage of the rasteriser 106, which rasterises the primitive to sampling points (e.g. pixels) and generates graphics fragments having appropriate positions (representing appropriate sampling positions) for rendering the primitive. It is possible for the primitive set-up stage to be separate from the rasteriser 106, e.g. at a stage of the graphics processing pipeline that is (e.g. immediately) before the rasteriser 106, but after the tiler 105.

The fragments generated by the rasteriser 106 are then sent onwards to the rest of the pipeline for processing.

The early Z/stencil stage 107 performs a Z (depth) test on fragments it receives from the rasteriser 106, to determine if any fragments can be discarded (culled) at this stage. In particular, the early Z/stencil stage 107 compares the depth values of (associated with) fragments issuing from the rasteriser 106 with the depth values of fragments that have already been rendered – these depth values are stored in a depth (Z) buffer that is part of the tile buffer 111 – to determine whether the new fragments are occluded by fragments that have already been rendered (or not). At the same time, an early stencil test is also carried out.

Fragments that pass the fragment early Z and stencil test stage 107 are then sent to the fragment shading stage 108. The fragment shading stage 108 performs the appropriate fragment processing operations on the fragments that pass the early Z and stencil tests, so as to process the fragments to generate the appropriate rendered fragment data.

This fragment processing may include any suitable and desired fragment shading processes, such as executing fragment shader programs on the fragments, applying textures to the fragments, applying fogging or other operations to the fragments, etc., to generate the appropriate fragment data. In the present example, the fragment shading stage 108 is in the form of a shader pipeline (a programmable fragment shader).

There is then a late fragment Z and stencil test state 109, which carries out, amongst other things, an end of pipeline depth test on the shaded fragments to determine whether a rendered fragment can actually be seen in the final image. This depth test uses the Z-buffer value for the fragment’s position stored in the Z buffer in the tile buffer 111 to determine whether the fragment data for the new fragments should replace the fragment data of the fragments that have already been rendered, by comparing the depth values of (associated with) fragments issuing from the fragment shading stage 108 with the depth values of fragments that have already been rendered (as stored in the depth buffer). This late fragment depth and stencil test stage 109 also performs any necessary late alpha and/or stencil tests on the fragments.

The fragments that pass the late fragment test stage 109 are then subjected to, if required, any necessary blending operations with fragments already stored in the tile buffer 111 in the blender 110. Any other remaining operations necessary on the fragments, such as dither, etc. (not shown) are also performed at this stage.

Finally, the (blended) output fragment data (values) are written to the tile buffer 111 from where they can e.g. be output to a frame buffer 113 for display. The depth value for an output fragment is also written appropriately to a Z buffer within the tile buffer 111. The tile buffer stores colour and depth buffers that store an appropriate colour, etc., or Z value, respectively, for each sampling point that the buffers represent (in essence for each sampling point of a tile that is being processed). These buffers store an array of fragment data that represents part (a tile) of the overall render output (e.g. image to be displayed), with respective sets of sample values in the buffers corresponding to respective pixels of the overall render output (e.g. each 2x2 set of sample values may correspond to an output pixel, where 4x multisampling is being used).

The tile buffer is provided as part of RAM that is located on (local to) the graphics processing pipeline (chip).

The data from the tile buffer 111 is input to a tile write out unit 112, and then output (written back) to an external memory output buffer, such as a frame buffer 113 of a display device (not shown). The display device may comprise, for example, a display comprising an array of pixels, such as a computer monitor or a printer.

The tile write out unit 112 downsamples the fragment data stored in the tile buffer 111 to the appropriate resolution for the output buffer (such that an array of pixel data corresponding to the pixels of the output device is generated) to generate output values (pixels) for output to the output buffer.

Once a tile of the render output has been processed and its data exported to a main memory (e.g. to a frame buffer 113 in a main memory) for storage, the next tile is then processed, and so on, until sufficient tiles have been processed to generate the entire render output (e.g. frame to be displayed). The process is then repeated for the next render output (e.g. frame) and so on. It should be noted that multiple tiles may be processed concurrently, for example each execution unit (e.g. shader core) may process a separate tile in parallel.

Other arrangements for a graphics processing pipeline are or course possible. The graphics processing pipeline 10 may be executed on and implemented by appropriate SIMT processing circuitry such as a graphics processing unit (GPU) that includes the necessary functional units, processing circuitry, etc., operable to execute the graphics processing pipeline stages.

In order to control a graphics processor (GPU) that is implementing a graphics processing pipeline to perform the desired graphics processing pipeline operations, the graphics processor typically receives commands and data from a driver, e.g. executing on a host processor (e.g. CPU), that indicates to the graphics processor the operations that it is to carry out and the data to be used for the operations.

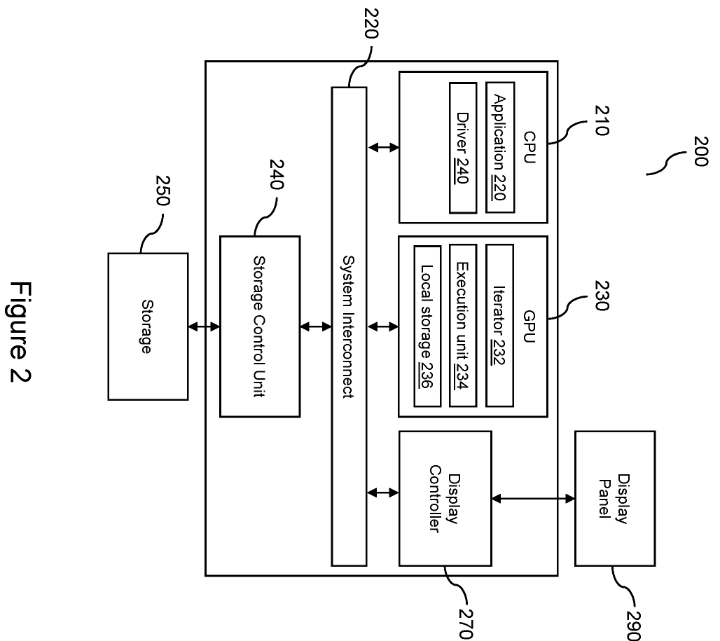

Accordingly, FIG. 2 shows schematically a typical computer graphics processing system 200, in which an application 220 such as a game executes on a host processor 210. When the application 220 requires graphics processing operations to be performed by an associated graphics processing unit (graphics processing pipeline) 230, it generates appropriate Application Programming Interface (API) calls that are interpreted by a driver 240 for the graphics processor 230 running on the host processor 210, to generate appropriate instructions (and data structures) for the graphics processor 230. The graphics processor 230 then generates graphics output required by the application 220 using the instructions (and data structures).

In particular, the graphics processor 230 comprises control circuitry (e.g. an iterator) 232, at least one (and in some examples more than one) execution unit 234 and a local storage 236 (e.g. tile buffer; where there is more than one execution unit, each execution unit preferably has its own associated local storage). A set of instructions is provided to the graphics processor 230 in response to instructions from the application 220/driver 240 running on the host system 210 for graphics output (e.g. to generate a frame to be displayed). For example, the driver 240 may send commands and data via system interconnect 220 to the graphics processor 230 by writing to storage 250. The control circuitry 232 breaks up the commands and data into one or more processing tasks, and assigns the tasks to the at least one execution unit 234, which processes the tasks in turn and outputs the processing results to the local storage 236. When a task completes, the processing output is written to storage 250 e.g. in compressed form. A storage control unit 240 can control the location in the storage 250 where the processing output is written.

Once a tile of a render output or frame has been processed and its data exported to storage 250 (e.g. to a frame buffer in storage 250), the next tile is then processed, and so on, until sufficient tiles have been processed to generate the entire render output (e.g. frame to be displayed). The process is then repeated for the next render output (e.g. frame) and so on. A frame (i.e. render output) may be displayed by the display panel 290 after the display controller 270 retrieves (and e.g. decompresses) the appropriate render output from the storage 250.

As noted above, GPU graphics processor 230 shown in FIG. 2 may include a plurality of execution units 234 which can be used to render graphics. Indeed, many contemporary data processing systems include processors having a plurality of execution units configured for executing a processing job as a respective plurality of threads. Such data processing systems may be termed single instruction, multiple thread (SIMT) processing circuits.

In illustrative examples, the present technology relates to compute shaders in which a processing job (e.g. a graphics job or a compute job) is described at the API level in terms of workgroups. For example, the driver 240 executing on host processor 210 shown in FIG. 2 may receive one or more processing jobs from the application 220, which may be a game running on the host processor 210. The driver 240 may be a graphics API such as OpenGL, DirectX or Vulkan, or may be another API such as OpenCL (it is noted that modern graphics APIs provide ways to issue compute jobs). The driver 240 submits processing jobs to the GPU 230 in terms of (1) a shader which works on workgroups of a certain size, typically specified in 3 dimensions and (2) a job which applies the shader above/over a certain range, typically specified in 3 dimensions. For example, a shader of size 4x4x4 (workgroup size) may be run over a range of 16x16x4 (job size). This will then run 16*16*4 = 1024 workgroups, each consisting of 4*4*4 = 64 threads. So in total, a number of 1024*64 = 65,536 threads will be run.

Inside the shader (1) it is possible to form queries regarding which workgroup id (3 dimensions) is being executed, and which thread id (3 dimensions). The shader has freedom to choose how to use these pieces of information, for example to calculate coordinates for writing a result to. Typically, the workgroup id and/or the thread id are used to generate an address for memory accesses.

When a processing job is executed using SIMT processing circuitry, such as a graphics processor, each thread is associated with respective coordinates within an operation space of the processing job, and each thread has access to at least one location in storage (e.g. one or more caches). The individual threads may be grouped together into “workgroups” (as noted above) and/or “warps”. By “warp” it is meant a collection of one or more threads of a processing job. The size of a warp is typically 16 threads, but may be 4, 8 or 32 threads. Other warp sizes are possible. The threads of one warp are run in lockstep, one instruction at a time, with each thread typically processing different data. Advantageously, it is possible to share instruction fetch and scheduling resources between all threads in a warp. By “workgroup” it is meant one or more threads. A workgroup can lead to one or more warps, depending on the total size of the workgroup. The total number of threads in a workgroup is the product of the numbers of threads along the width, height and depth of the workgroup, and the threads in a workgroup may be divided into warps.

In graphics rendering, workgroups are typically executed by graphics processing circuitry in in the order defined by the shader. In cases where workgroups are launched in raster order, and assuming workgroup id impacts memory access location, memory accesses will occur in raster order. Due to the large number of caches provided in modern data processing systems, processing efficiency is enhanced when concurrent memory accesses have high spatial locality. However, in at least some cases, executing instructions in raster order can lead to concurrent memory accesses having low spatial locality, at times leading to decreased processing efficiency and cache misses.

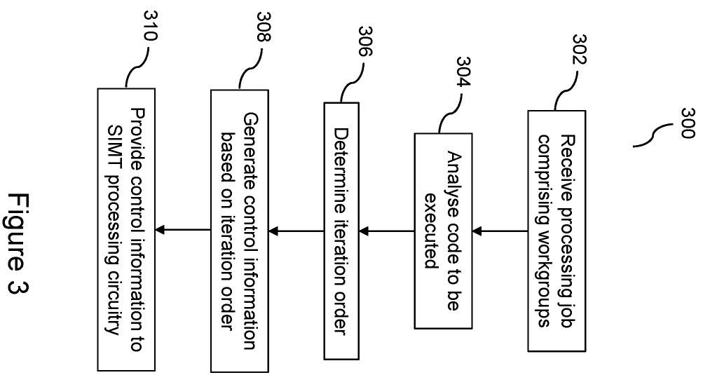

FIG. 3 shows a method 300 according to an example of the disclosure. The method 300 is a computer-implemented method for scheduling execution of at least one processing job on single instruction, multiple thread (SIMT) processing circuitry, such as the GPU 230 shown in FIG. 2. The method 300 comprises: receiving at least one processing job comprising one or more workgroups (step 302); analysing code to be executed (step 304); determining an iteration order (step 306); generating control information based on the iteration order (step 308); and providing the control information to SIMT processing circuitry (step 310).

In an example, the method 300 may be carried out at the graphics processing system 200 shown in FIG. 2. In particular, the method 300 may be carried out by a driver executing on host processing circuitry, such as the driver 240 executing on host processor 210 shown in FIG. 2.

At step 302, the method 300 comprises receiving at least one processing job comprising one or more workgroups. For example, the driver 240 executing on host processor 210 shown in FIG. 2 may receive at least one processing job comprising one or more workgroups from the application 220. In an example, the application 220 may be a game, running on the host processor 210. The driver 240 which receives the at least one processing job at step 302 may be a graphics API such as OpenGL, DirectX or Vulkan, or may be another API such as OpenCL.

The at least one processing job received at step 302 may be a processing job which operates on data stored in memory, such as image data or tensor data. The at least one processing job received in step 302 may be an API workload, for example a graphics API or compute API workload. Examples of workloads for use in aspects of the present disclosure include compute jobs, geometry shading jobs, fragment jobs, among others.

In examples, each workgroup received in step 302 comprises one or more threads. Each thread received in step 302 is associated with respective coordinates within an operation space of the at least one processing job. During execution of a particular thread by the SIMT processing circuitry, that thread will have access to at least one location in storage (e.g. in local storage 236 of the GPU 230 shown in FIG. 2). Each location in storage to which a thread has access may store image data or tensor data.

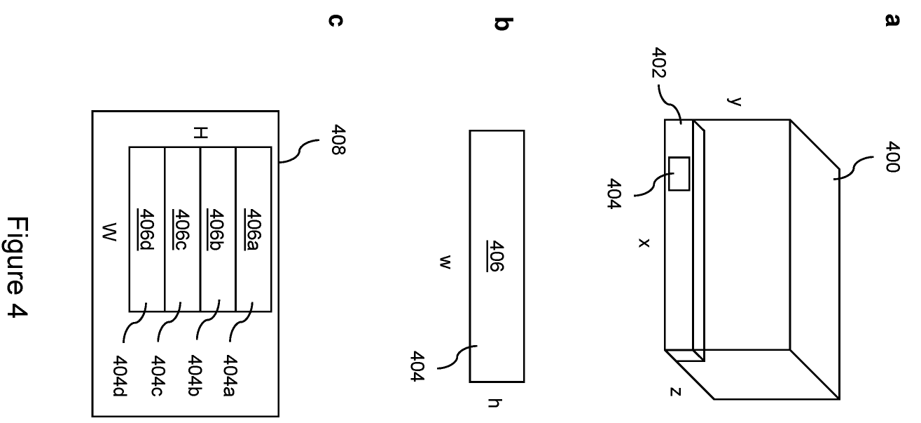

FIG. 4 (panel a) shows an example operation space 400 of a processing job, such as a processing job received in step 302. The operation space 400 is an n-dimensional operation space. In the example of FIG. 4 (panel a), the operation space 400 is a 3-dimensional operation space extending in x-, y- and z-directions, but other dimensional operation spaces may be used (e.g. a 2-dimensional operation space extending in x- and y-directions only).

The processing job to which the operation space 400 corresponds includes an example workgroup 402. In this example, the workgroup 402 is located within the operation space 400 (i.e. it is associated with coordinates in the operation space 400) and extends in the x-, y- and z- directions. The example workgroup 402 comprises one or more threads 404. Each thread 404 within the workgroup 402 is associated with respective coordinates within the operation space 400 of the processing job.

Where the processing job to which the operation space 400 corresponds is an image processing job then the x- and y- coordinates in the operation space 400 may correspond to x- and y- coordinates in an image to be processed.

The processing job to which the operation space 400 corresponds (e.g. the processing job received at step 302) has a job size specifying the number of workgroups 402 there are in each direction (e.g. x-, y- and z-directions) of the operation space 400. Each workgroup 402 has a workgroup size specifying the number of threads 404 to launch in each direction (e.g. x-, y- and z-directions) of the operation space 400.

During execution of the thread 404 by the SIMT processing circuitry, the thread 404 accesses data in storage. As illustrated in FIG. 4 (panel b), each thread 404 of the example workgroup 402 has an access footprint 406. The access footprint 406 of each thread 404 has at least a width dimension w and a height dimension h. The width dimension w may be greater than the height dimension h, equal to the height dimension h, or less than the height dimension h. Panel c of FIG. 4 shows a plurality of access footprints 406a, 406b, 406c and 406d in example storage 408 for a respective plurality of threads 404a, 404b, 404c and 404d.

The access footprint of the workgroup 402 can be determined by combining the access footprint 406 of each thread 404 in the workgroup 402 with the workgroup size of that workgroup 402, while compensating for overlap of the access footprints 406 of the threads 404 as commonly seen in image filters. The access footprint of the workgroup 402 comprises at least a width dimension W and a height dimension H. The width dimension W may be greater than the height dimension H, equal to the height dimension H, or less than the height dimension H. As will be explained in further detail below, the access footprints of the workgroups of a processing job can be used to schedule the execution of said workgroups such that concurrent memory accesses have higher spatial locality than otherwise would be the case. Ensuring that concurrent memory accesses have high spatial locality helps to ensure higher cache hit rates and provides improved processing efficiency.

Returning to FIG. 3, at step 304 the method 300 comprises analysing the code to be executed by the SIMT processing circuitry during execution of the one or more threads (i.e. the threads comprised in the one or more workgroups of the at least one processing job received at step 302). Analysing the code to be executed by the SIMT processing circuitry at step 304 comprises determining the access footprints of the one or more workgroups. The purpose of the analysis carried out at step 304 is to infer a storage access pattern of the one or more workgroups of the at least one processing job received at step 302.

FIG. 5 shows a method 500 according to an example of the disclosure. The method 500 is a computer-implemented method for analysing code to be executed by SIMT processing circuitry during execution of one or more threads.

In an example, the method 500 may be carried out at the processing system 200 of FIG. 2. In particular, the method 500 may be carried out by a driver executing on host processing circuitry, such as the driver 240 executing on host processor 210 shown in FIG. 2.

The method 500 may be used to implement the analysis carried out at step 304 of the method 300. For example, the analysis carried out at step 304 may comprise, for each workgroup of the processing job received at step 302: determining a size of the workgroup (step 504); determining an access footprint of each thread of the workgroup (506); and combining the size of the workgroup and the access footprint of each thread to determine an access footprint of the workgroup (step 508).

At step 502, the method 500 comprises selecting a workgroup. In an example, a workgroup of a processing job is selected for analysis. A workgroup (e.g. workgroup 402) may be selected by the driver 240 executing on host processor 210 shown in FIG. 2. Any suitable workgroup of the processing job may be selected by the driver at step 502.

At step 504, the method 500 comprises determining a size of the workgroup selected at step 502. The workgroup size specifies the number of threads to launch in each direction (e.g. x-, y- and z-directions) of the operation space of the processing job to which the workgroup belongs. The workgroup size may be determined by the driver by inspecting the workgroup and/or by inspecting each thread of the workgroup.

At step 506, the method 500 comprises determining access footprints of each thread of the workgroup selected at step 502. The access footprint of a thread 404 may be determined by inspecting the code to be executed by the SIMT processing circuitry during execution of the thread 404. The access footprint of a thread may be a w x h footprint, as discussed above with respect to FIG. 4 (panel b). The width of a thread may be greater than its height, equal to its height, or less than its height. In examples, the footprint of a thread may also have a depth dimension, i.e. the footprint of a thread is not limited to w x h.

It is common for the access footprint of each thread to be the same for all threads in a workgroup. If the driver is unable to determine the access footprint of one or more threads in a workgroup, the access footprint for thread of that workgroup will be determined according to a default access footprint. The default access footprint may be a footprint of 1, 1 (i.e. w = 1, h = 1).

At step 508, the method 500 comprises determining an access footprint of the workgroup selected at step 502. The access footprint of the workgroup is determined by combining the workgroup size of that workgroup (determined at step 504) with the access footprint of each thread in the workgroup (determined at step 504), while also compensating for any overlap of the access footprints 406 of the threads 404 as commonly seen in image filters. The result is a W x H footprint.

Once step 508 has completed, the method 500 proceeds to step 510, where the method 500 ends and method 300 resumes at step 306. Since all workgroups of the processing job are identical when it comes to the analysis carried out at steps 504-508 (i.e. the results of steps 504-508 will be identical for all workgroups of the processing job), the method 500 may be carried out only once, i.e. on one workgroup, to effect step 304 of the method 300.

On completion of the method 500/step 304, the access footprints of each workgroup of the processing job will have been determined. Collectively, the access footprints of the workgroup of the processing job constitute a storage access pattern of the processing job. The storage access pattern can be used to schedule execution of the workgroups such that during execution of the processing job by the SIMT processing circuitry, concurrent memory accesses have high spatial locality.

Returning to FIG. 3, at step 306, the method 300 comprises determining an iteration order for the one or more workgroups based on the storage access pattern. The iteration order is determined on the basis of spatial locality of memory accesses during execution of the at least one processing job. Advantageously, concurrent memory accesses having high spatial locality lead to higher cache hit rates and improved processing efficiency.

In examples, the iteration order is determined at step 306 based on the access footprints of the one or more workgroups. In further examples, the iteration order may also be determined such that the shape of output data is aligned to the shape of compression units in storage.

The iteration order may be determined at step 306 according to an iteration policy. An iteration policy may be a rules-based policy used by the driver to determine a suitable iteration order for the workgroups of a processing job, the rules being defined with respect to the shapes of access footprints of the workgroups, and optionally based on the shape of the data in storage. In general, the iteration policy will be biased towards executing workgroups along a particular direction. The purpose of executing workgroups along a particular direction is to ensure that the storage access pattern of the processing job is as square as possible.

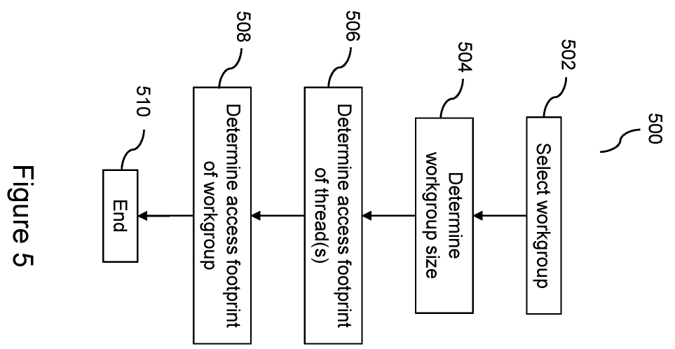

In an example illustrated in FIG. 6, the iteration policy used to determine the iteration order at step 306 stipulates that workgroups are executed one line at a time along a determined direction in the operation space of the processing job until the entire space has been walked. According to this illustrative example, the determined direction may be chosen as either the x- or y-direction. Where the width dimensions of the workgroups of the processing job are greater than their height dimension (i.e. W>H for all workgroups of the processing job), then the iteration order, i.e. the order in which the workgroups are to be executed, will be one line at a time along a first direction (see iteration order 604a in FIG. 6, panel a), and otherwise the iteration order is one line at a time along a second direction (see iteration order 604b in FIG. 6, panel b). In this example, to ensure high spatial locality of the concurrent memory accesses the first direction is the y-direction and the second direction is the x-direction. The iteration order 604a proceeds through the workgroups 602 along the y-direction of the operation space 600. The alternative iteration order 604b proceeds through the workgroups 602 along the x-direction of the operation space 600.

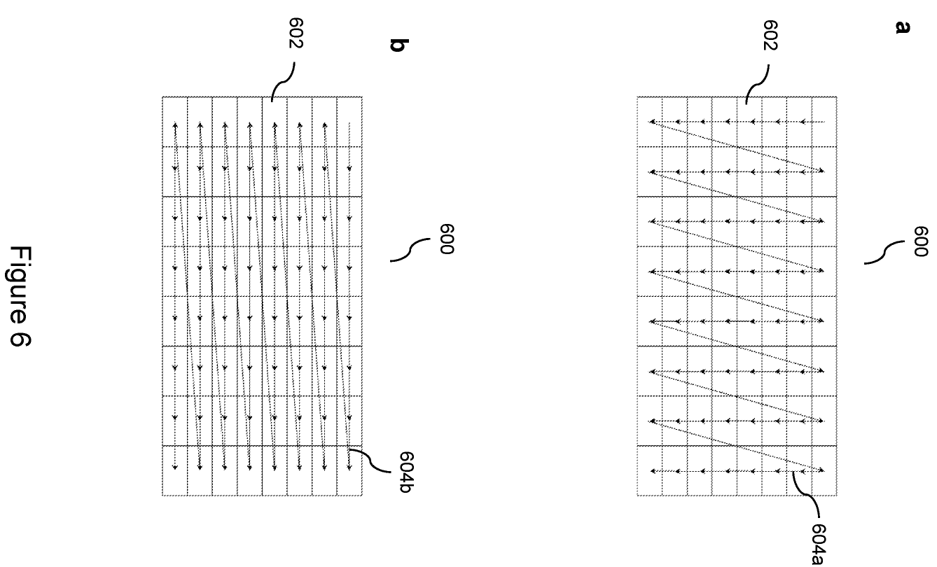

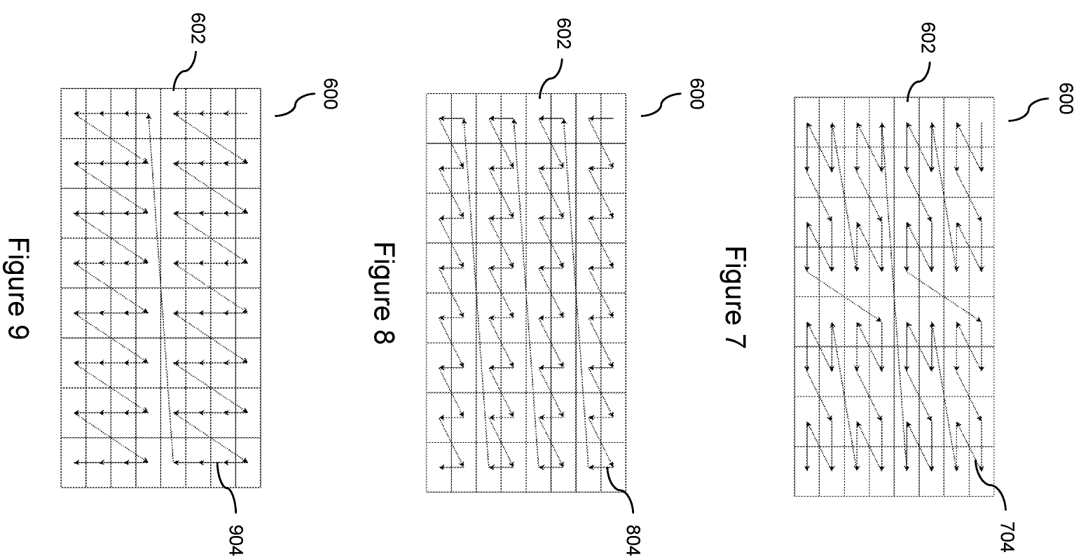

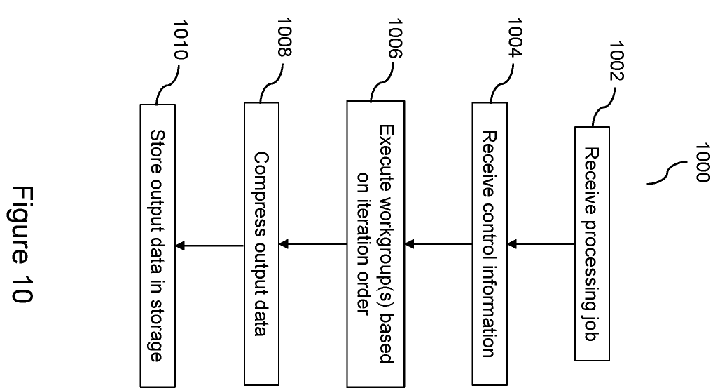

FIGS. 7-9 show further examples of space-filling iteration orders 704, 804, 904 that may be used according to other iteration policies. These further example iteration orders 704, 804, 904 iterate several lines of workloads at a time, forming “stripes” that increase in one or another direction. Iteration policies based on other similar space filling curves or Morton-order may also be used.

Returning to FIG. 3, at step 308, the method 300 comprises generating control information for scheduling execution of the one or more workgroups on the SIMT processing circuitry. In examples, the control information generated at step 308 is based on the iteration order determined at step 306 (i.e. the iteration order which may be based on an iteration policy). The control information comprises instructions that may be interpreted by the SIMT processing circuitry, such as by the control circuitry 232 of the GPU 230 shown in FIG. 2.

At step 310, the method 300 comprises providing the control information to the SIMT processing circuitry which is configured for executing the processing job that was received and analysed by the driver at steps 302 and 304. For example, the control circuitry 232 of the GPU 230 shown in FIG. 2 may receive the control information from the driver 240 of the host processor 210.

Providing the control information to the SIMT processing circuitry at step 310 may involve writing the control information in storage accessible by the SIMT processing circuitry such that the control information can be read/retrieved by the SIMT processing circuitry before and/or during execution of the workgroups of the processing job. In an example, the control information may be written by the driver 240 of the host processor 210 shown in FIG. 2 to the local storage 236 of the GPU 230.

Use of the method 300 allows a driver to determine a suitable iteration order for the workgroups of a processing job, and also allows the driver to provide corresponding control information to SIMT processing circuitry. In this way, the SIMT processing circuitry can execute workgroups in a suitable order for ensuring high spatial locality of concurrent memory accesses. The method 300 ensures that the spatial locality of concurrent memory accesses by the SIMT processing circuitry will be optimised, and will be higher than would otherwise be the case when e.g. executing workgroups in raster order. As will be appreciated, in use the method 300 ensures higher cache hit rates and improved processing efficiency.

FIG. 10 shows a method 1000 according to an example of the disclosure. The method 1000 is a computer-implemented method for executing at least one processing job comprising one or more workgroups on single instruction, multiple thread (SIMT) processing circuitry, such as the GPU 230 shown in FIG. 2. The method 1000 comprises: receiving a processing job comprising one or more workgroups (step 1002); receiving control information (step 1004); executing the workgroups based on an iteration order (step 1006); compressing the output data (step 1008); and storing the output data in storage (step 1010).

The method 1000 may be carried out by SIMT processing circuitry after method 300 of FIG. 3 has completed, for example after step 310 of the method 300. the SIMT processing circuitry is configured to execute the one or more workgroups based on the iteration order to produce output data and store the output data in storage, for example as either compressed or uncompressed data.

At step 1002, the method 1000 comprises receiving at least one processing job comprising one or more workgroups. For example, the GPU 230 may receive a processing job from the driver 240 executing on host processor 210 shown in FIG. 2. In an example, application 220 may be a game, running on the host processor 210. The GPU 230 may receive the processing job from the application 220 via the driver 240. The driver 240 may be a graphics API such as OpenGL, DirectX or Vulkan, or may be another API such as OpenCL.

The at least one processing job received at step 1002 may be a processing job which operates on data stored in memory, such as image data or tensor data. The at least one processing job received in step 1002 may be an API workload, for example a graphics API or compute API workload. Examples of workloads for use in aspects of the present disclosure include compute jobs, geometry jobs, fragment jobs, among others.

In a similar manner to that described above with respect to step 302 of the method 300, each workgroup received in step 1002 comprises one or more threads and each thread is associated with respective coordinates within an operation space of the at least one processing job (e.g. operation space 400 shown in FIG. 4). During execution of a particular thread by the SIMT processing circuitry, that thread will have access to at least one location in storage (e.g. in local storage 236 of the GPU 230 shown in FIG. 2). Each location in storage to which a thread has access may store image data or tensor data.

At step 1004, the method 1000 comprises receiving control information, such as the control information generated at step 308 of the method 300. In examples, the control information is received by the GPU 230 shown in FIG. 2 from the driver 240 executing on the host CPU 210. The control information is for scheduling execution of the one or more workgroups based on an iteration order, in particular the iteration order determined at step 306 of the method 300. The control information may be received and interpreted by e.g. the iterator 232 shown in FIG. 2.

As will be appreciated, steps 310 and 1004 may be carried out simultaneously.

At step 1006, the method 1000 comprises executing the one or more workgroups (i.e. the one or more workgroups comprised in the processing job received at step 1002). The one or more workgroups are executed by the SIMT processing circuitry. For example, the one or more workgroups may be executed by the execution units 234 of the GPU 230 of FIG. 2.

Execution of the one or more workgroups at step 1006 results in output data being produced. The output data may be image data or tensor data. At optional step 1008, the method 1000 comprises compressing the output data in one or more compression units. At step 1010 the output data is stored in storage. For example, the GPU 230 may store the output data as compressed or uncompressed data in storage 250, where it will be accessible to e.g. the display controller 270.

As outlined above, the execution of the one or more workgroups of the processing job received in step 1002 by the SIMT processing circuitry at step 1006 is based on the control information received in step 1004. As such, the SIMT processing circuitry executes the workgroups in a suitable order for ensuring high spatial locality of concurrent memory accesses, higher cache hit rates and improved processing efficiency.

As will be appreciated by one skilled in the art, the present techniques may be embodied as a system, method or computer program product. Accordingly, the present techniques may take the form of an entirely hardware embodiment, an entirely software embodiment, or an embodiment combining software and hardware.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as VerilogTM or VHDL (Very high-speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to the preferred embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

The examples and conditional language recited herein are intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its scope as defined by the appended claims.

Furthermore, as an aid to understanding, the above description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to limit the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labelled as a "processor", may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term "processor" or "controller" should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

It will be clear to one skilled in the art that many improvements and modifications can be made to the foregoing exemplary embodiments without departing from the scope of the present techniques.

What is claimed is:

1. A computer-implemented method for scheduling execution of at least one processing job on single instruction, multiple thread (SIMT) processing circuitry, the method comprising:
receiving at least one processing job comprising one or more workgroups, wherein each workgroup comprises one or more threads, and wherein each thread is associated with respective coordinates within an operation space of the at least one processing job;
analysing code to be executed by the SIMT processing circuitry during execution of the one or more threads to infer a storage access pattern of the one or more workgroups;
determining an iteration order for the one or more workgroups based on the storage access pattern; and
generating control information for scheduling execution of the one or more workgroups on the SIMT processing circuitry based on the iteration order.

2. The method of claim 1, wherein the SIMT processing circuitry is graphics processing circuitry and the at least one processing job comprises at least one of a graphics workload or a compute workload.

3. The method of claim 1, wherein the method further comprises:
providing the control information to the SIMT processing circuitry;
executing, by the SIMT processing circuitry, the one or more workgroups based on the iteration order to produce output data; and
storing, by the SIMT processing circuitry, the output data in storage.

4. The method of claim 3, wherein the method further comprises:
compressing the output data in one or more compression units.

5. The method of claim 4, wherein the iteration order is determined such that the shape of the output data is aligned to the shape of the compression units.

6. The method of claim 1, wherein the iteration order is determined on the basis of spatial locality of memory accesses during execution of the at least one processing job.

7. The method of claim 1, wherein the at least one processing job has a job size specifying the number of workgroups in each direction.

8. The method of claim 1, wherein each workgroup has a workgroup size specifying the number of threads to launch in each direction.

9. The method of claim 1, wherein analysing the code to be executed by the SIMT processing circuitry during execution of the one or more threads comprises determining access footprints of the one or more workgroups.

10. The method of claim 9, wherein the iteration order is based on the access footprints of the one or more workgroups.

11. The method of claim 9, wherein the access footprint of each workgroup comprises at least a width dimension and a height dimension.

12. The method of claim 11, wherein when the width dimension is greater than the height dimension, the iteration order is along a first direction, and otherwise the iteration order is along a second direction.

13. The method of claim 1, wherein analysing the code to be executed by the SIMT processing circuitry during execution of the one or more threads comprises, for each workgroup:
determining a size of the workgroup; and
determining an access footprint of each thread; and
combining the size of the workgroup and the access footprint of each thread to determine an access footprint of the workgroup while compensating for overlap.

14. The method of claim 13, comprising, for at least one workgroup, determining an access footprint of each thread as a default access footprint.

15. The method of claim 1, wherein the iteration order is determined according to an iteration policy.

16. The method of claim 1, wherein the at least one processing job operates on image data or tensor data.

17. The method of claim 1, wherein the method is carried out by a driver executing on host processing circuitry.

18. Single instruction, multiple thread (SIMT) processing circuitry configured for executing at least one processing job comprising one or more workgroups, each workgroup comprising one or more threads, wherein each thread is associated with respective coordinates within an operation space of the at least one processing job, wherein the SIMT processing circuitry is configured to carry out a method comprising:
receiving control information for scheduling execution of the one or more workgroups based on an iteration order, the control information is indicative of the iteration order; and
executing the one or more workgroups according to the iteration order to produce output data.

19. A system comprising host processing circuitry and single instruction, multiple thread (SIMT) processing circuitry, wherein a driver executing on the host processing circuitry is configured to carry out a method comprising:
receiving at least one processing job comprising one or more workgroups, wherein each workgroup comprises one or more threads, and wherein each thread is associated with respective coordinates within an operation space of the at least one processing job;
analysing code to be executed by the SIMT processing circuitry during execution of the one or more threads to infer a storage access pattern of the one or more workgroups;
determining an iteration order for the one or more workgroups based on the storage access pattern; and
generating control information for scheduling execution of the one or more workgroups on the SIMT processing circuitry based on the iteration order.

20. The system of claim 19, wherein the SIMT processing circuitry is graphics processing circuitry.
